(19) United States
(12) Patent Application Publication
(10) Pub. No.: US 2023/0191840 A1
(43) Pub. Date: Jun. 22, 2023

(54) NON-PNEUMATIC TIRE WITH IMPROVED SHEAR BAND

(71) Applicant: The Goodyear Tire & Rubber Company, Akron, OH (US)

(72) Inventors: Francesco Sportelli, Bettembourg (LU); Claude Ernest Félix Boes, Erpeldange-sur-Sûre (LU); Stefan Wilms, Helmdange (LU); Romain Jack Rodolphe Mersch, Boust (FR)

(21) Appl. No.: 18/045,235

(22) Filed: Oct. 10, 2022

Related U.S. Application Data
(60) Provisional application No. 63/265,619, filed on Dec. 17, 2021.

(51) Int. Cl. B60C 9/18; B60C 7/10; B60C 7/14

(52) U.S. Cl. CPC B60C 9/1807; B60C 7/107; B60C 7/146

(57) ABSTRACT

A shear band and a non-pneumatic tire is described which includes a ground contacting annular tread portion; a shear band, and a connecting web positioned between a hub and the shear band. The shear band is preferably comprised of a three-dimensional spacer fabric having a first and second layer connected by connecting members. The three-dimensional spacer fabric has a defined depth. The first and second layer of fabric of the three-dimensional spacer structure are reinforced with a respective first and second layer of non-crimped fabric, eliminating the need for a rubber shear layer and reinforcement layers commonly used for the shear band.

### FIELD OF THE INVENTION

The present invention relates generally to vehicle tires and non-pneumatic tires, and more particularly, to an improved shear band for a non-pneumatic tire.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominant today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed gasses. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

The purpose of the shear band is to transfer the load from contact with the ground through tension in the spokes or connecting web to the hub, creating a top loading structure. When the shear band deforms, its preferred form of deformation is shear over bending. The shear mode of deformation occurs because of the inextensible membranes located on the outer portions of the shear band. Prior art non-pneumatic tire typically has a shear band made from rubber materials sandwiched between at least two layers of inextensible belts or membranes. The disadvantage to this type of construction is that the use of rubber significantly increases the cost and weight of the non-pneumatic tire. Another disadvantage to the use of rubber is that is generates heat, particularly in the shear band. Furthermore, the rubber in the shear band needs to be soft in shear, which makes it difficult to find the desired compound.

Thus, an improved non-pneumatic tire is desired that has all the features of the pneumatic tires without the drawback of the need for air inflation is desired.

### BRIEF DESCRIPTION OF THE DRAWINGS

The present invention will be better understood through reference to the following description and the appended drawings, in which:

FIG. 1 is a perspective view of a first embodiment of a non-pneumatic tire of the present invention;

FIG. 2 is a cross-sectional view of a first embodiment of a shear band and outer tread ring;

FIG. 3A is a perspective view of a three-dimensional fabric structure;

FIG. 3B is a cross-sectional view of example pile reinforcement member configurations of the three-dimensional fabric structure of FIG. 3A;

FIG. 3C illustrate an exemplary three-dimensional fabric structure with a closely knit upper and lower fabric with FIG. 8 shaped pile reinforcement members that are in a closely spaced configuration;

FIG. 3D illustrates an exemplary three-dimensional fabric structure with an upper and lower fabric layer with straight pile reinforcement members;

FIG. 4A illustrates the formation of a non-crimped fabric formed of two fiber layers oriented at +45 deg and −45 deg;

FIGS. 4B-4C illustrate the attachment of the non-crimped fabric layers of FIG. 4A to a three-dimensional spacer fabric structure by warp knitting;

FIG. 4D illustrates a woven fabric, while FIG. 4E illustrates a non-crimped fabric;

FIG. 4F illustrates the formation of non-crimped fabric with multi-axial fiber layers at different orientations;

FIG. 5A illustrates a three-dimensional spacer fabric with its upper and lower fabric layers being reinforced with a non-crimped fabric having a biaxial reinforcement structure and a rubber or thermoplastic layer; and

FIG. 5B is an exploded view of the three-dimensional spacer fabric structure of FIG. 5A.

### DEFINITIONS

The following terms are defined as follows for this description.

“Auxetic material” means a material that has a negative Poisson's ratio.

“Cord” means the twisted fiber or filament of polyester, rayon, nylon or steel which form a reinforcement cord.

“Equatorial Plane” means a plane perpendicular to the axis of rotation of the tire passing through the centerline of the tire.

“Fabric” means a network of cords which extend in in multiple directions.

“Free area” is a measure of the openness of the fabric per DIN EN 14971, and is the amount of area in the fabric plane that is not covered by yarn. It is a visual measurement of the tightness of the fabric and is determined by taking an electronic image of the light from a light table passing through a six inch by six inch square sample of the fabric and comparing the intensity of the measured light to the intensity of the white pixels.

“Inextensible” means that a given layer has an extensional stiffness greater than about 25 Ksi.

“Knitted” is meant to include a structure producible by interlocking a series of loops of one or more yarns by means of needles or wires, such as warp knits and weft knits.

“Three-dimensional spacer structure” means a three-dimensional structure composed from two outer layers of fabric, each outer layer of fabric having reinforcement members (such as yarns, filaments or fibers) which extend in a first and second direction, wherein the two outer layers are connected together by reinforcement members (yarns, filaments or fibers) or other knitted layers that extend in a defined third direction. An “open” three-dimensional spacer structure is comprised of individual pile fibers or reinforcements that connect the first and second layer of fabric. A “closed” three-dimensional structure utilizes fabric piles that connect the first and second layers.

“Yarn” means a continuous strand of textile fibers or filaments. A monofilament yarn has only a single filament with or without twist.

“Woven” is meant to include a structure produced by multiple yarns crossing each other at right angles to form the grain, like a basket.

### DETAILED DESCRIPTION OF THE INVENTION

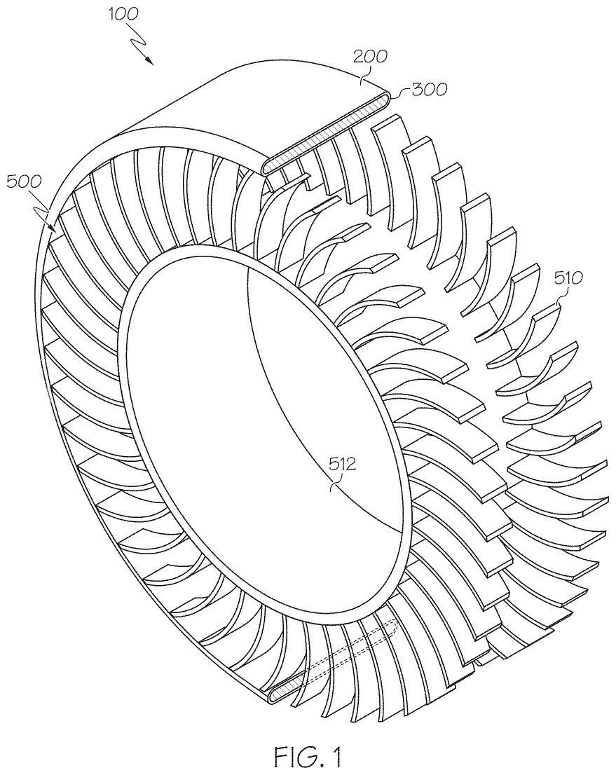

A first embodiment of a non-pneumatic tire 100 of the present invention is shown in FIG. 1. The tire of the present invention includes a radially outer ground engaging tread 200, a shear band 300, and a connecting web 500. The tire tread 200 may include elements such as ribs, blocks, lugs, grooves, and sipes as desired to improve the performance of the tire in various conditions. The connecting web 500 is mounted on a hub 512 and may have different designs, such as spokes or an elastomeric web. The non-pneumatic tire of the present invention is designed to be a top loading structure, so that the shear band 300 and the connecting web 500 efficiently carry the load. The shear band 300 and the connecting web are designed so that the stiffness of the shear band is directly related to the spring rate of the tire. The connecting web is designed to be a stiff structure when in tension that buckles or deforms in the tire footprint and does not compress or carry a compressive load. This allows the rest of the connecting web not in the footprint area the ability to carry the load, resulting in a very load efficient structure. It is desired to allow the shearband to bend to overcome road obstacles. The approximate load distribution is preferably such that approximately 90-100% of the load is carried by the shear band and the upper portion of the connecting web, so that the lower portion of the connecting web carry virtually zero of the load, and preferably less than 10%.

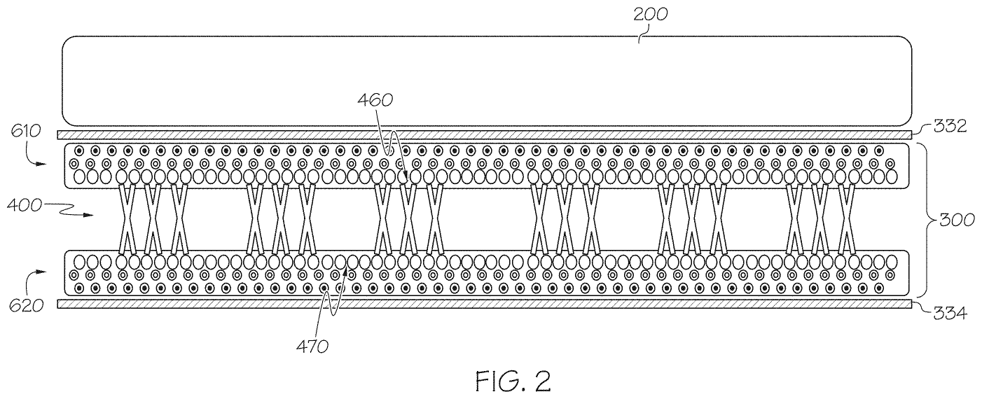

The shear band 300 is preferably an annular structure that is located radially inward of the tire tread 200. The shear band includes a three-dimensional spacer structure 400, shown in FIG. 2. The three-dimensional spacer structure 400 may be positioned between a first and second layer of gum rubber 332,334 (not shown to scale). The gum rubber 332,334 may be as thick as desired.

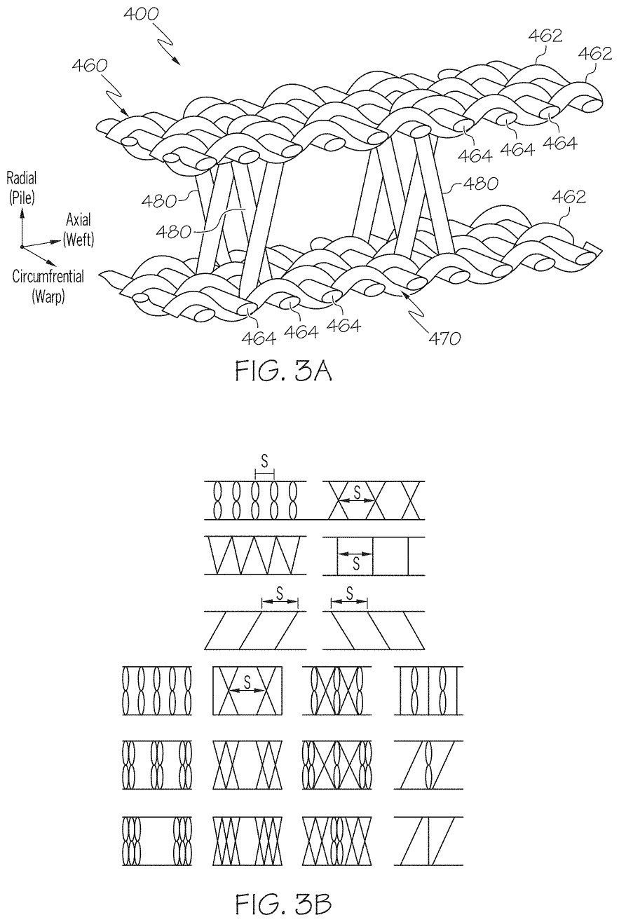

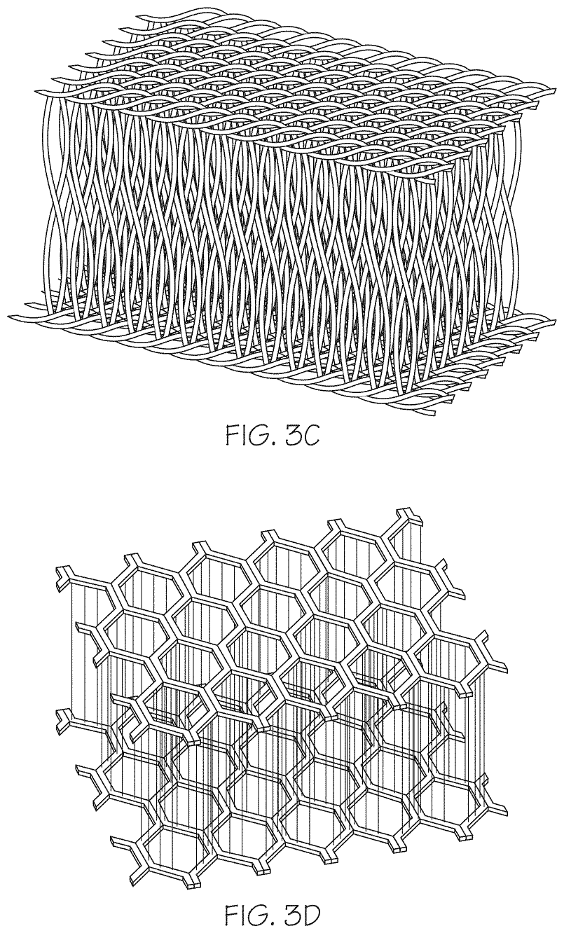

As shown in FIG. 2 and in FIG. 3A, the three-dimensional spacer structure 400 is a type of structure that is formed of a first and second layer of fabric 460,470, wherein each layer of fabric is formed from reinforcement members that may be knitted, woven, nonwoven, interlaced or non-interlaced. The reinforcement members are preferably multifilament and formed of polyester or nylon material. The first and second layers 460,470 of fabric are preferably oriented parallel with respect to each other and are interconnected with each other by a plurality of pile connecting members 480 that extend in a third or pile dimension. As shown in FIG. 3B, the pile connecting members 480 may form a straight connection of the first and second layers 460,470 that may extend in the radial direction, or be angled with the radial direction. The pile connecting members 480 may form an X shape, or letter 8 shape or combinations thereof. The pile connecting members are preferably monofilaments made of polyester material. FIG. 3C illustrate an exemplary three-dimensional spacer structure with a closely knit upper and lower fabric with FIG. 8 shaped pile reinforcement members is closely spaced configuration. FIG. 3D illustrates an exemplary three-dimensional spacer structure with upper and lower fabric layers having a pattern of hexagonal shaped recesses formed with straight pile reinforcement members.

The perpendicular distance between the connecting layers 460,470 or Z direction dimension of the three-dimensional structure is in the range of about 2 millimeters to about 25 millimeters, more preferably about 3-10 millimeters, and even more preferably in the range of 5-10 mm.

The three-dimensional spacer structure 400 is preferably oriented in the shear band so that the first and second layers 460,470 are aligned in parallel relation and extend across the axial direction of the nonpneumatic tire, as well as extending in the circumferential direction. The pile reinforcement members of three-dimensional fabric structure 400 are preferably aligned with the radial direction of the non-pneumatic tire.

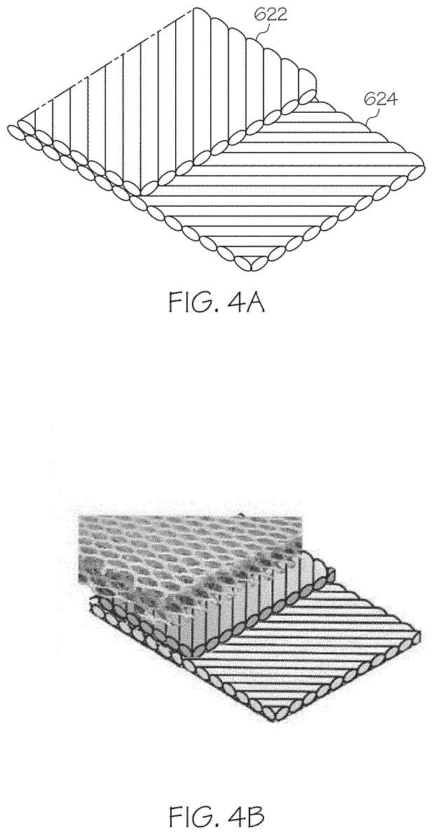

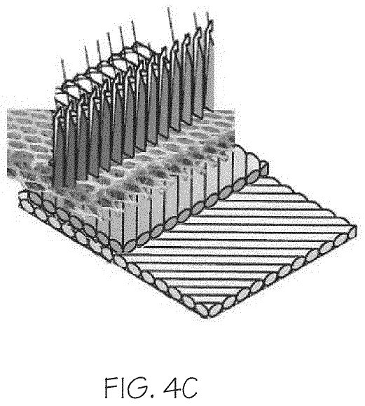

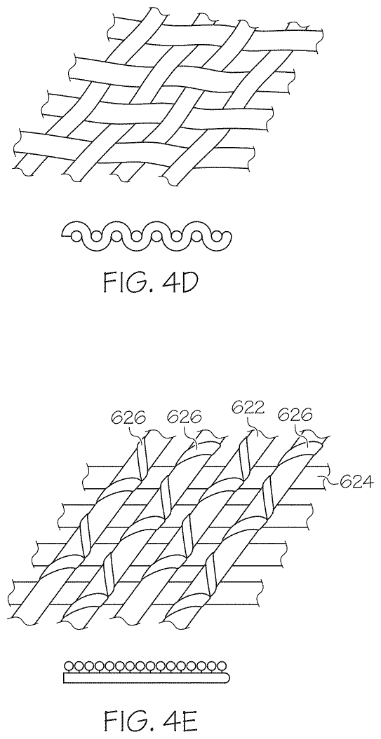

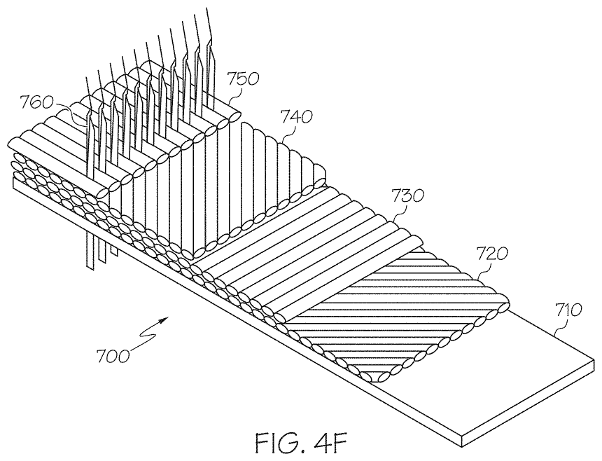

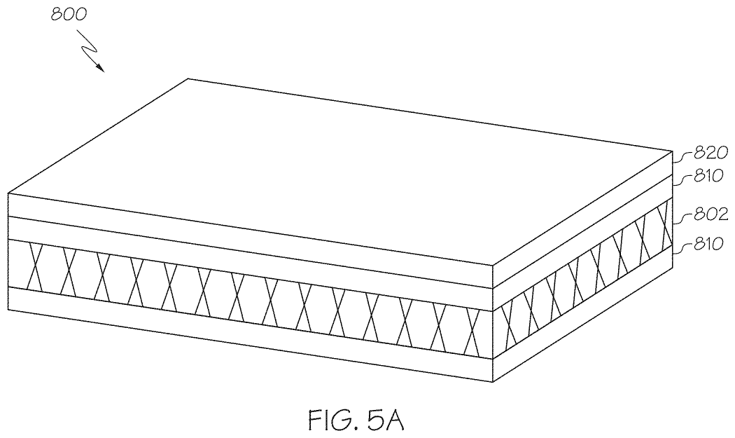

As shown in FIG. 2, the three-dimensional spacer structure has upper and lower fabric layers 460,470 that are each knitted or otherwise joined to a non-crimped fabric layer (NCF) 610,620 respectively. As shown in FIGS. 4A-4C, the NCF layer 420 is formed from two fiber layers 622,624 wherein the orientation of the fiber layers are selected for optimum performance. In this example, the fiber orientation of layers 622,624 are +45 degrees and −45 degrees. The invention is not limited to this fiber orientation, as other orientations may be utilized such as zero degree, 90 degree and in the range of 0 to 180 degrees. The NCF layers are joined together with the lower layer of the three-dimensional spacer structure by warp knitting as shown in FIG. 4C. The process is preferably repeated for the upper layer of the three-dimensional spacer structure, so that the top and bottom layers are each reinforced with a NCF layer.

FIG. 4E illustrates a NCF layer having a bi-axial reinforcement structure with fiber layers 622,624 oriented perpendicular to each other and secured together with warp knitting yarn 626. As compared to a woven fabric as shown in FIG. 4D, the NCF layer has highly aligned fibers without the undulations of the woven fabric. FIG. 4F illustrates that the NCF reinforcement layer 700 may comprise multiple layers, and as shown, includes an optional nonwoven layer 710, a fiber layer 720 of 45 degrees, a fiber layer 730 of 90 degrees, a fiber layer 740 of −45 degrees, and a fiber layer 750 of zero degrees that are all knitted together with a warp knitting yarn 760. The angular orientations refer to the angle the fibers make with the tire circumferential plane. For example, a fiber orientation of zero degrees, means that the fibers are oriented in the circumferential direction, and 90 degrees are oriented perpendicular to the zero degree fibers and are aligned with the axial direction of the tire.

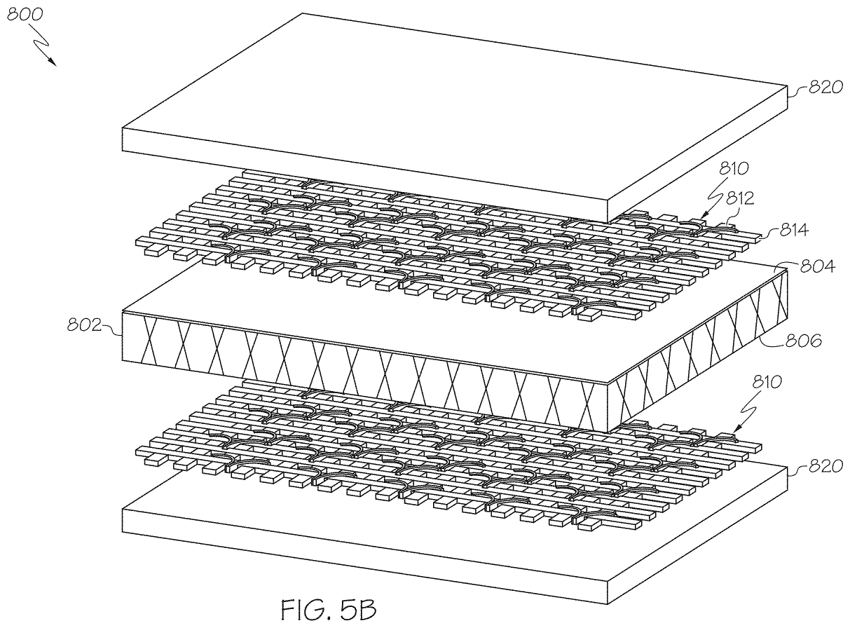

FIGS. 5A and 5B illustrate a second embodiment of the shear band 800 of the present invention. The shear band 800 includes a three-dimensional spacer structure 802 that has an upper and lower fabric surface 804,806 that is knitted to a NCF fabric with a biaxial reinforcement structure 810, wherein the fibers 812,814 are perpendicular to each other and oriented at zero degrees and 90 degrees with respect to the tire mid-circumferential plane.

Both the three-dimensional spacer fabric and the integrated NCF layer are coated with a skin layer formed of rubber, urethane, polyurethane, or thermoplastic materials such as polypropylene, polyester terephthalates, polyamides, polyethylene, thermoplastic copolymers, and thermoplastic co-polyesters. The skin layer may be applied by spraying, brushing, stamping, 3D printing, liquid bath or other methods known to those skilled in the art.

The NCF layers as described above may be formed of glass fibers, carbon fibers or hybrid fibers combining glass and carbon fibers. The three-dimensional spacer structure may be additionally reinforced with cords or wires or combinations thereof. The resulting shearband composite structure is strong and ultralight, and dispenses with the need for additional belt reinforcing layers or rubber shear layers.

Preferably, the three-dimensional fabric structure 400 is treated with an RFL adhesive prior to application of the skin layer, which is a well-known resorcinol-formaldehyde resin/butadiene-styrene-vinyl pyridine terpolymer latex, or a blend thereof with a butadiene/styrene rubber latex, that is used in the tire industry for application to fabrics, fibers and textile cords for aiding in their adherence to rubber components (for example, see U.S. Pat. No. 4,356,219.) The reinforcement members may be single end dipped members (i.e., a single reinforcement member is dipped in RFL adhesive or adhesion promoter.)

The three-dimensional fabric structure 400 may have a density in the range of 700-1000 gram/meter2 as measured by DIN 12127. The compression stiffness of the three-dimensional fabric structure 400 may range from 50 to 600 kPa as measured by DIN/ISO 33861, and more preferably range from 100 to 250 kPa.

Applicants understand that many other variations are apparent to one of ordinary skill in the art from a reading of the above specification. These variations and other variations are within the spirit and scope of the present invention as defined by the following appended claims.

What is claimed:

1. A nonpneumatic tire having an outer tread ring, wherein the outer tread ring further comprises a shear band, wherein the shear band includes a three-dimensional spacer structure, wherein the three-dimensional spacer structure is formed from a first and second layer of fabric, wherein the first and second layer of fabric are connected to a respective first and second layer of non-crimped fabric.

2. The nonpneumatic tire of claim 1 wherein the non-crimped layer of fabric is formed from a first and second layer of fiber.

3. The nonpneumatic tire of claim 1 wherein the first and second layer of fabric of the three-dimensional spacer structure are each knitted to the respective non-crimped layer of fabric.

4. The nonpneumatic tire of claim 2 wherein the fibers in the first layer are parallel with respect to each other and angled at a first angle, and the fibers in the second layer are parallel with respect to each other and angled at a second angle, wherein the first angle is different than the second angle.

5. The nonpneumatic tire of claim 4 wherein the fibers in the first layer are angled at 45 degrees, and the fibers in the second layer are angled at 90 degrees.

6. The nonpneumatic tire of claim 4 wherein the fibers in the first layer are angled at +45 degrees, and the fibers in the second layer are angled at −45 degrees.

7. The nonpneumatic tire of claim 4 wherein the fibers in the first layer are angled at 0 degrees, and the fibers in the second layer are angled at 90 degrees.

8. The nonpneumatic tire of claim 1 wherein the first and second layer of fiber is formed of glass fibers, carbon fibers or mixtures thereof.

9. The nonpneumatic tire of claim 1 wherein the first and second layers of fabric of the three-dimensional spacer structure are separated by a radial distance in the range of 2 to 15 millimeters.

10. The nonpneumatic tire of claim 1 wherein the first and second layers of fabric of the three-dimensional spacer structure are separated by a radial distance in the range of 3-8 mm millimeters.

11. The nonpneumatic tire of claim 1 wherein the first and second layers of fabric of the three-dimensional spacer structure are separated by a radial distance in the range of 5-10 mm millimeters.

12. The nonpneumatic tire of claim 1 wherein the cross section of the three-dimensional spacer structure is nonuniform.

13. The nonpneumatic tire of claim 1 wherein the pile connecting members extend in the radial direction and are perpendicular to the first and second layer of material.

14. The nonpneumatic tire of claim 1 wherein the tread and shear band do not have a shear layer of rubber or elastomer.

15. The nonpneumatic tire of claim 1 wherein the tread and shear band do not have a layer of reinforcements.

16. The nonpneumatic tire of claim 1 wherein the first and second layer of fabric of the three-dimensional spacer structure and the respective non-crimped layer of fabric are coated with a skin layer formed of rubber, urethane, polyurethane, or thermoplastic materials such as polypropylene, polyester terephthalates, polyamides, polyethylene, thermoplastic copolymers, and thermoplastic co-polyesters.

17. The nonpneumatic tire of claim 16 wherein the skin layer is applied by spraying, brushing, stamping, 3D printing, or liquid bath.

18. The nonpneumatic tire of claim 1 wherein the non-crimped layer of fabric includes a nonwoven layer or film.

19. The nonpneumatic tire of claim 1 wherein the non-crimped layer of fabric is reinforced with organic or metal reinforcement cords.
